(19) United States
(12) Patent Application Publication
(10) Pub. No.: US 2005/0151988 A1
(43) Pub. Date: Jul. 14, 2005

(54) Image forming apparatus

(75) Inventor: Hideo Suto, Tokyo (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Oki Data Corporation

(21) Appl. No.: 11/028,937

(22) Filed: Jan. 4, 2005

(30) Foreign Application Priority Data
Jan. 9, 2004 (JP) 2004-004547

(51) Int. Cl. G06F 15/00; G06F 3/12

(52) U.S. Cl. 358/1.13; 358/1.16; 358/1.15

(57) ABSTRACT

In an image forming apparatus, a network database stores plural setting items and set values, a protocol information storing unit stores predetermined group information so that the plural setting items stored in the network database are grouped together every related setting item. A print control unit obtains the related setting item from the network database on the basis of the group information when it receives a print-output request of the setting items from printer setting information print accepting means (1) or (2). When the network administrator requests the output of the set values regarding the network of the image forming apparatus, the set values regarding all setting items are print-outputted and the time and attention to detect the necessary information become unnecessary.

### BACKGROUND OF THE INVENTION

1. Field of the Invention

The invention relates to an image forming apparatus for print-outputting a list of set values related to a network.

2. Related Background Art

In recent years, in many cases, an image forming apparatus such as a printer or the like is connected to a network such as an LAN (Local Area Network) or the like and used in common by a plurality of PCs (personal computers). In such a network environment, in the case where set values related to the network or the like are changed, a network administrator often requests the image forming apparatus to print-output set values. The set values are numerical values or information showing various attributes of the single printer or the printers on the network.

In the conventional image forming apparatus, when the output of the network related set values is requested through an operation panel of the image forming apparatus or through the network, all set values set in a network interface card or the like are print-outputted as a list. Therefore, even the set values of unnecessary setting items are print-outputted. Thus, surplus time and attention are necessary until the network administrator detects necessary information.

To solve such a problem, a technique that the operation to change set values by the network administrator is simplified or the like has also been opened (for example, refer to JP-A-2002-323946).

However, even according to such a technique, the items which are not always necessary are displayed by a display unit.

It is a problem to be solved that when the network administrator requests an output of set values regarding the network of the image forming apparatus, the set values regarding all of the setting items are print-outputted, so that surplus time and attention are required to detect the necessary information.

### SUMMARY OF THE INVENTION

It is an object of the invention to provide an image forming apparatus for print-outputting a list of set values related to a network.

According to the present invention, there is provided an image forming apparatus having a plurality of setting items, comprising:
a setting item memory which stores the plurality of setting items;
a group information memory which stores predetermined group information so that the plurality of setting items stored in the setting item memory are grouped together to every related setting item; and
a print control unit which, when a print-output request of the setting items is received, obtains the related setting item from the setting item memory on the basis of the group information and print-outputs the related setting item.

In the image forming apparatus, the print control unit comprises a selection item accepting means which receives the print-output request every group on the basis of a selection item so that the related setting item is grouped together to a predetermined group; and a setting information print formatting means which obtains the setting item from the setting item memory on the basis of the group information corresponding to the selection item and outputs the obtained setting item in a predetermined format.

Moreover, in the image forming apparatus, the group information is predetermined protocol information so that the plurality of setting items stored in the setting item memory are grouped together every predetermined protocol.

Further, according to the present invention, there is provided an image forming apparatus having a plurality of setting items, comprising:
a setting item memory which stores the plurality of setting items;
a change point information storing unit which stores information regarding the setting item whose setting contents have been changed among the plurality of setting items stored in the setting item memory; and
a print control unit which, when a print-output request of the setting items is received, obtains a predetermined setting item from the setting item memory on the basis of the information regarding the changed setting item and print-outputs the predetermined setting item.

In the image forming apparatus, the print control unit comprises: a selection item accepting means which receives the print-output request on the basis of the predetermined selection item which designates the setting item whose setting contents have been changed; and a setting information print formatting means which obtains the setting item from the setting item memory on the basis of the information regarding the setting item which corresponds to the selection item and whose setting contents have been changed and outputs the obtained setting item in a predetermined format.

Moreover, in the image forming apparatus, the change point information storing unit stores identification information of the setting item whose setting contents have been changed.

Moreover, in the image forming apparatus, the change point information storing unit further stores a plurality of summary information in which the setting item is grouped together to a plurality of category and set value sharing information in which the setting item shares same setting contents.

Further, according to the present invention, there is provided an image forming apparatus having a plurality of setting items, comprising:
a setting item memory which stores the plurality of setting items;
a change point information storing unit which stores information regarding the setting item whose setting contents have been changed among the plurality of setting items stored in the setting item memory; and
a print control unit which, when a print-output request of the setting items is received, obtains a predetermined setting item from the setting item memory on the basis of the information regarding the changed setting item and print-outputs the predetermined setting item in a predetermined changed expressing format.

In the image forming apparatus, the print control unit comprises a selection item accepting means which receives the print-output request on the basis of a predetermined selection item which designates the setting item whose setting contents have been changed; and a setting information print formatting means which obtains the setting item from the setting item memory on the basis of the information regarding the setting item which corresponds to the selection item and whose setting contents have been changed and outputs the obtained setting item in the predetermined changed expressing format.

Since only the set values of the necessary setting items are print-outputted or a set value list on which only the set values of the necessary setting items are displayed by a specific displaying method is print-outputted, an effect that the time and attention to detect the necessary information can be saved is obtained. Further, in the case where only the set values of the necessary setting items are print-outputted, an effect that wastefulness of consumables can be avoided is also obtained.

The above and other objects and features of the present invention will become apparent from the following detailed description and the appended claims with reference to the accompanying drawings.

### BRIEF DESCRIPTION OF THE DRAWINGS

FIG. 1 is a block diagram of a construction in the embodiment 1;

FIGS. 2A, 2B, and 2C show examples of a print-output of set values in the embodiment 1;

FIG. 3 is a flowchart for the whole operation of a printer in the embodiment 1;

FIG. 4 is a flowchart for the operation of network setting information print formatting means in the embodiment 1;

FIG. 5 is an explanatory diagram of an information searching method in the embodiment 1;

FIG. 6 is a block diagram of a construction in the embodiment 2;

FIGS. 7A and 7B show examples of a print-output of set values in the embodiment 2;

FIG. 8 is a flowchart for the whole operation of a printer in the embodiment 2;

FIG. 9 is a flowchart for the operation of network setting information print formatting means in the embodiment 2;

FIG. 10 is an explanatory diagram of an information searching-method in the embodiment 2 (part 1);

FIG. 11 is an explanatory diagram of the information searching method in the embodiment 2 (part 2);

FIG. 12 is a block diagram of a construction in the embodiment 3;

FIGS. 13A and 13B show examples of a print-output of set values in the embodiment 3;

FIG. 14 is a flowchart for the whole operation of a printer in the embodiment 3;

FIG. 15 is a flowchart for the operation of network setting information print formatting means in the embodiment 3;

FIG. 16 is an explanatory diagram of an information searching method in the embodiment 3 (part 1);

FIG. 17 is an explanatory diagram of the information searching method in the embodiment 3 (part 2);

FIG. 18 is a block diagram of a construction in the embodiment 4;

FIGS. 19A and 19B show examples of a print-output of set values in the embodiment 4;

FIG. 20 is a flowchart for the whole operation of a printer in the embodiment 4;

FIG. 21 is a flowchart for the operation of network setting information print formatting means in the embodiment 4;

FIG. 22 is an explanatory diagram of an information searching method in the embodiment 4 (part 1);

FIG. 23 is an explanatory diagram of the information searching method in the embodiment 4 (part 2).

### DETAILED DESCRIPTION OF THE PREFERRED EMBODIMENTS

Since a CPU (central processing unit) to control a whole image forming apparatus constructs a print control unit by using control means which operates in accordance with a predetermined program, it can be realized without increasing the number of parts.

### Embodiment 1

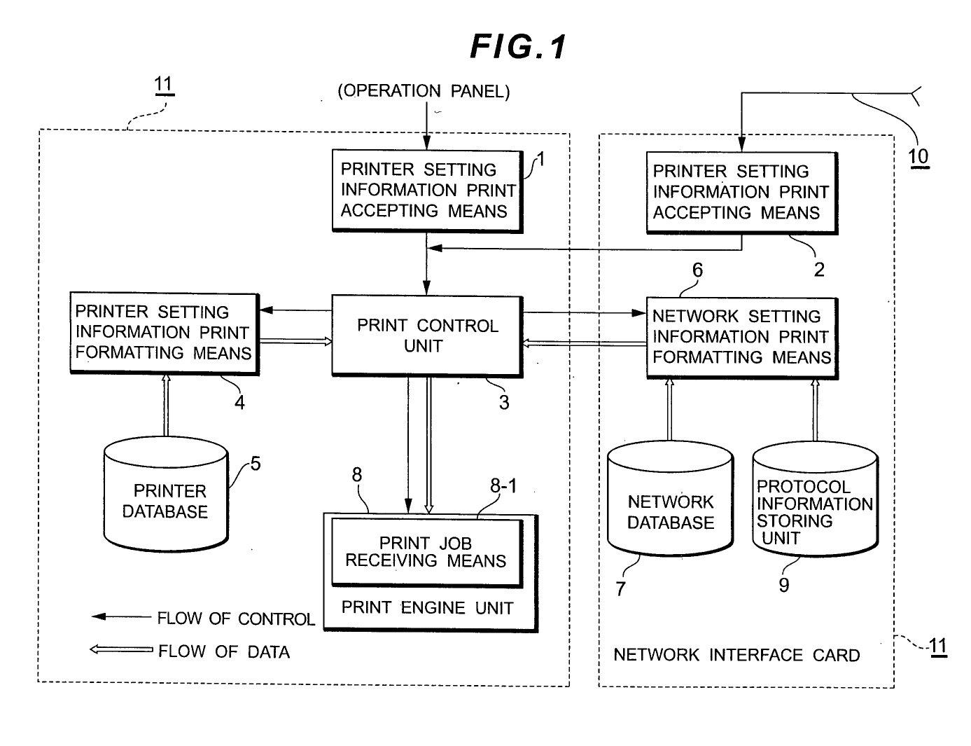

FIG. 1 is a block diagram of a construction in the embodiment 1.

As shown in the diagram, a printer 12 of the embodiment 1 comprises: printer setting information print accepting means (1) 1 which receives a print request of set values that are inputted from an operation panel or the like of a printer main body; printer setting information print accepting means (2) 2 which receives a print request of set values through a network 10 to which the printer 12 is connected; a print control unit 3 which deciphers contents of the print request of the set values received from the printer setting information print accepting means (1) 1 or the printer setting information print accepting means (2) 2 and controls a printing process; printer setting information print formatting means 4 which forms a print format of the set values regarding the printer on the basis of the control of the print control unit 3; and a printer database 5 which stores the set value of each setting item regarding the printer main body.

Further, the construction of the embodiment 1 comprises: network setting information print formatting means 6 which forms a print format of the set values regarding the network on the basis of the control of the print control unit 3; a network database 7 which stores the set value of each setting item regarding the network 10; a print engine unit 8 which print-outputs predetermined set values on the basis of the control of the print control unit 3; and a protocol information storing unit 9 which stores predetermined protocol information such as setting items or the like which are grouped together every protocol in order to group together a plurality of setting items stored in the network database 7, for example, every related protocol. The print engine unit 8 has print job receiving means 8-1, therein, which receives a print job from the print control unit 3.

The network setting information print formatting means 6, the network database 7, and the protocol information storing unit 9 are arranged in a network interface card 11 or the like which is used to connect the printer 12 to the network 10.

Ordinarily, in the print control unit 3, the CPU for controlling the whole printer 12 plays its role in accordance with a predetermined program. Further, the printer setting information print accepting means (1) 1, the printer setting information print accepting means (2) 2, the printer setting information print formatting means 4, the network setting information print formatting means 6, and the print job receiving means 8-1 are constructed by control means of the print control unit 3 which operates in accordance with the predetermined program. The predetermined program has been stored in a partial area in a ROM or a RAM (not shown) in which programs for controlling the whole printer have been stored.

The operation of the printer in the embodiment 1 will now be described.

Prior to explaining the operation, the contents of the print-output of the set values will be described.

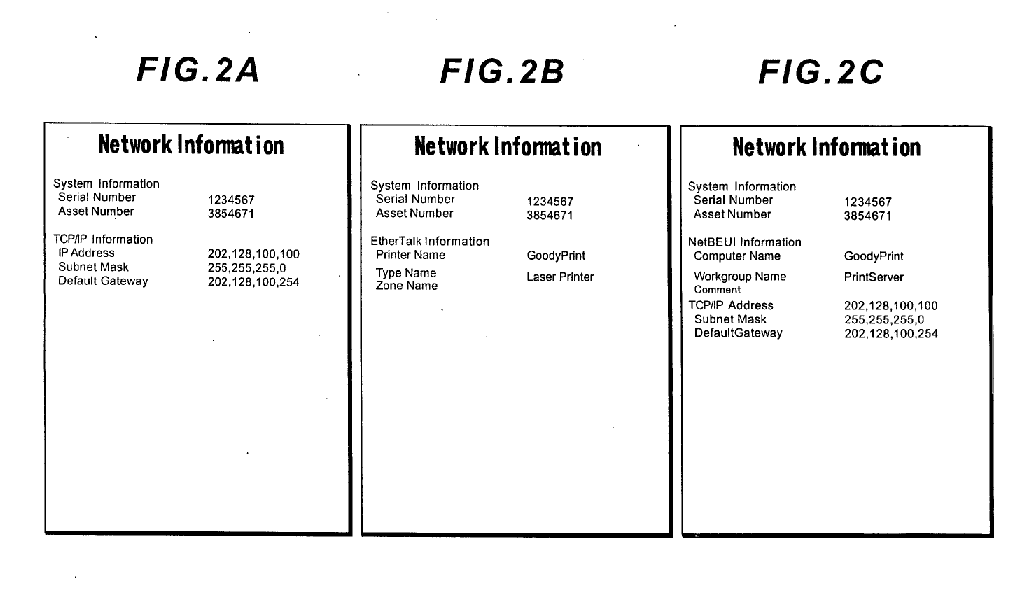

FIGS. 2A, 2B, and 2C show examples of the print-output of the set values in the embodiment 1.

The drawings show the examples of the diagrams each of which is obtained by print-outputting the set values of the related setting items every protocol. FIG. 2A shows the example in which the set values of the setting items regarding “TCP/IP”. FIG. 2B shows the example in which the set values of the setting items regarding “Ether Talk”. FIG. 2C shows the example in which the set values of the setting items regarding “NetBEUI”. “System Information” is printed as a common item on each print sheet. This is because it is desirable to clarify by which printer the printing has been performed. As for a set value list which is print-outputted in the prior art, all of the print images as shown in FIGS. 2A, 2B, and 2C have been outputted in a lump.

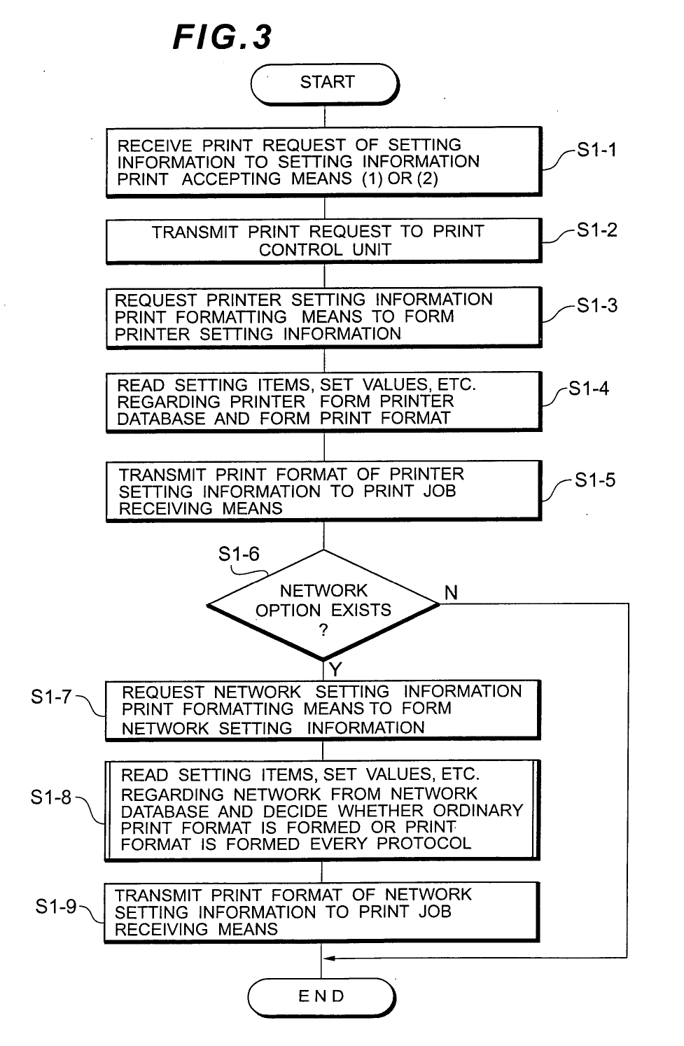

FIG. 3 is a flowchart for the whole operation of the printer in the embodiment 1.

This flowchart shows the operation which is executed until the print control unit 3 (FIG. 1) transmits a print format of printer setting information to the print engine unit 8 (FIG. 1) after it received a print-output request of the set values through the printer setting information print accepting means (1) 1 (FIG. 1) or the printer setting information print accepting means (2) 2. Processes in steps S1-1 to S1-9 will now be described in order of the processing steps.

Step S1-1

The print-output request of the set values is inputted to the printer setting information print accepting means (1) 1 (FIG. 1) or the printer setting information print accepting means (2) 2 (FIG. 1). Information showing whether the printing is executed on the basis of the conventional list or the printing of each protocol is executed and, in the case of printing every protocol, information showing which protocol is designated are included in the print-output request. Those information is inputted, for example, by a method whereby a network administrator selects predetermined selection items when he requests the print-output. At the same time, identification (ID) information to specify that the request is the print-output request is added to the print-output request.

Step S1-2

The print control unit 3 (FIG. 1) receives the print-output request of the set values through the printer setting information print accepting means (1) 1 (FIG. 1) or the printer setting information print accepting means (2) 2 (FIG. 1). The print control unit 3 (FIG. 1) recognizes here that the received signal is the print-output request of the set values on the basis of the ID information to specify that the request is the print-output request.

Step S1-3

The print control unit 3 (FIG. 1) requests the printer setting information print formatting means 4 (FIG. 1) to form printer setting information.

Step S1-4

On the basis of the control of the print control unit 3 (FIG. 1), the printer setting information print formatting means 4 (FIG. 1) obtains the setting items and their set values from the printer database 5 (FIG. 1), arranges them in order, forms the print format of the set values regarding the printer, and transmits the formed print format of the set values to the print control unit 3 (FIG. 1).

Step S1-5

The print control unit 3 (FIG. 1) transmits the print format of the set values regarding the printer which was received from the printer setting information print formatting means 4 (FIG. 1) to the print engine unit 8 (FIG. 1) through the print job receiving means 8-1. Further, prior to transmitting the print format of the set values regarding the printer, the print control unit 3 (FIG. 1) transmits a reception inhibiting command of another job to the print job receiving means 8-1 (FIG. 1). This is because it will be confused if another request (other than the print-output request of the set values) is inputted between the print-output request of the set values regarding the printer and the subsequent print-output request of the set values regarding the network.

Step S1-6

The print control unit 3 (FIG. 1) discriminates whether or not the output request of the setting information regarding the network is included in the print-output request. If it is included, the processing routine advances to step S1-7. If it is not included, the processing routine is finished.

Step S1-7

The print control unit 3 (FIG. 1) requests the network setting information print formatting means 6 (FIG. 1) to form the print format of the setting information regarding the network.

Step 51-8

On the basis of the control of the print control unit 3 (FIG. 1), the network setting information print formatting means 6 (FIG. 1) forms the print format of the setting information regarding the network on the basis of a predetermined method and transmits the formed print format of the set values to the print control unit 3 (FIG. 1). The predetermined method will be described in detail later with reference to other flowcharts. The predetermined method here is a method of print-outputting the set values of the setting items grouped together every protocol.

Step S1-9

The print control unit 3 (FIG. 1) transmits the print format of the setting information regarding the network received from the network setting information print formatting means 6 (FIG. 1) to the print engine unit 8 (FIG. 1) through the print job receiving means 8-1 and finishes the processing flow. Further, prior to transmitting the print format of the set values regarding the network, the print control unit 3 (FIG. 1) transmits a reception inhibition cancelling command of another job to the print job receiving means 8-1 (FIG. 1).

The predetermined method in step S1-8 mentioned above will now be described.

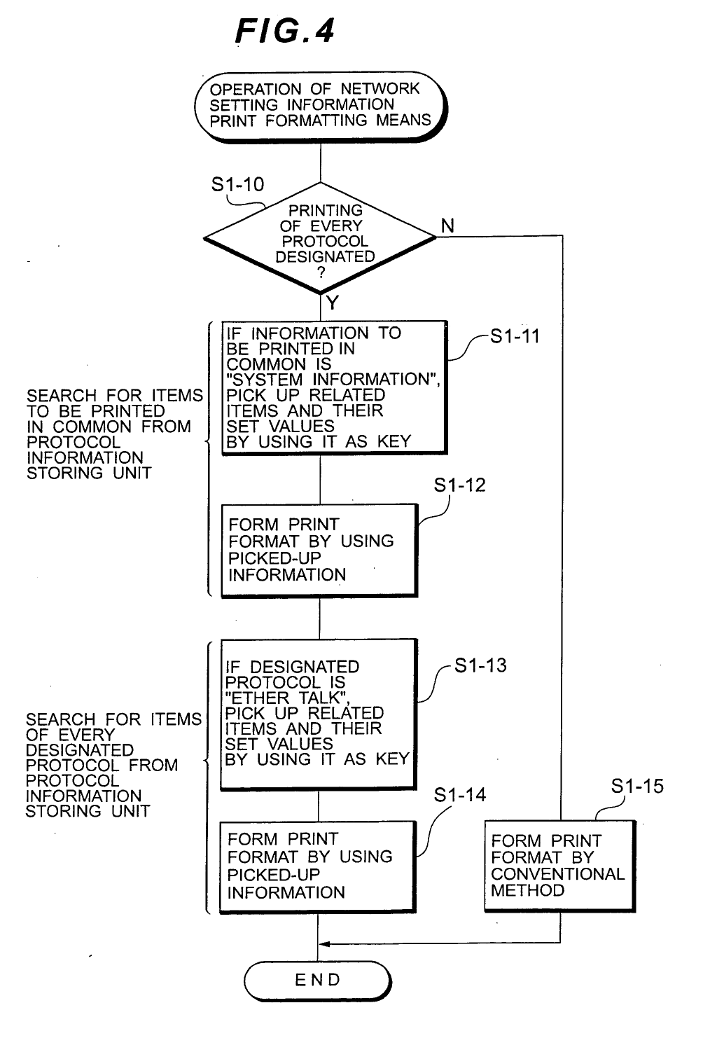

FIG. 4 is a flowchart for the operation of the network setting information print formatting means in the embodiment 1.

This diagram is the flowchart for describing in detail the processing method in step S1-8. Processes in steps S1-10 to S1-15 will now be described in order of the processing steps.

Step S1-10

The print control unit 3 (FIG. 1) discriminates whether the received print-output request indicates that the print-output of the conventional setting item list is required or the print-output of each protocol is required. In the case of requesting the print-output of each protocol, step S1-11 follows. In the case of requesting the print-output of the conventional setting item list, step S1-15 follows. Those information is inputted, for example, by a method whereby the network administrator selects predetermined selection items when he requests the print-output in step S1-1.

Step S1-11

On the basis of the control of the print control unit 3 (FIG. 1), the network setting information print formatting means 6 (FIG. 1) obtains the setting items grouped together in “System Information” from the protocol information storing unit 9 (FIG. 1) by using “System Information” (an example), as a key, which is print-outputted in common with respect to all protocols and obtains the set values of those setting items from the network database 7 (FIG. 1).

Step S1-12

On the basis of the control of the print control unit 3 (FIG. 1), the network setting information print formatting means 6 (FIG. 1) forms the print format of “System Information” as a common item described with reference to FIG. 2 by using the obtained setting items and the set values.

Step S1-13

On the basis of the control of the print control unit 3 (FIG. 1), the network setting information print formatting means 6 (FIG. 1) detects which protocol the network administrator has selected at the time of the print-output request in step S1-1. It is now assumed that “Ether Talk” has been selected. The network setting information print formatting means 6 uses “Ether Talk” as a key, obtains the setting items which are grouped together to “Ether Talk” from the protocol information storing unit 9 (FIG. 1) and obtains the set values of the setting items from the network database 7 (FIG. 1).

Step S1-14

On the basis of the control of the print control unit 3 (FIG. 1), the network setting information print formatting means 6 (FIG. 1) forms the print format regarding “Ether Talk” by adding the obtained set value of the setting items to a lower portion of the common item and finishes the processing flow.

Step S1-15

On the basis of the control of the print control unit 3 (FIG. 1), the network setting information print formatting means 6 (FIG. 1) forms the conventional print format in which all of the network related set values are listed and finishes the processing flow.

The information searching method in steps S1-11 and S1-13 will now be described.

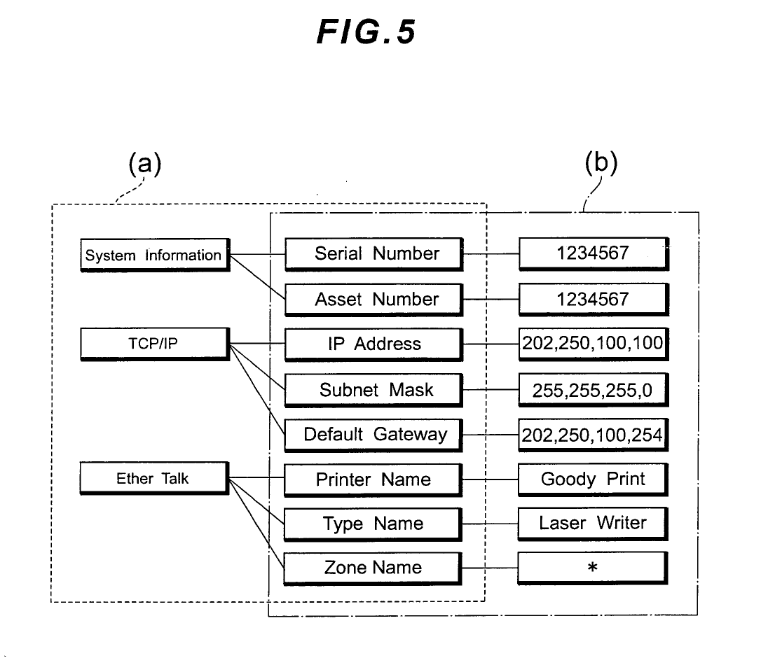

FIG. 5 is an explanatory diagram of the information searching method in the embodiment 1.

(a) corresponds to a portion stored in the protocol information storing unit 9 (FIG. 1) and (b) corresponds to a portion stored in the network database 7 (FIG. 1).

As shown in (a), a relation between a category (including a protocol) and the setting items which are grouped together thereto has been stored in the protocol information storing unit 9 (FIG. 1). As shown in (b), the setting items and their set values have been stored in the network database 7 (FIG. 1).

Therefore, the network setting information print formatting means 6 (FIG. 1) searches the protocol information storing unit 9 (FIG. 1) on the basis of the selected category (including a protocol), detects the setting items, searches the network database 7 (FIG. 1) on the basis of the detected setting items, and detects the set values. The category, setting items, and set values detected as mentioned above are arranged as shown in FIGS. 2A to 2C and print-outputted.

As described above, according to the embodiment, since only the set values of the necessary setting items are print-outputted, an effect that the time and attention to detect the necessary information can be saved is obtained. Further, an effect that wastefulness of consumables can be avoided is also obtained.

Although the invention has been described above on the assumption that all of the printer setting information print accepting means (1) 1 (FIG. 1), the printer setting information print accepting means (2) 2 (FIG. 1), the printer setting information print formatting means 4 (FIG. 1), and the network setting information print formatting means 6 (FIG. 1) are constructed by the control means of the print control unit 3 (FIG. 1), the invention is not limited to this example. That is, all or a part of the printer setting information print accepting means (1) 1 (FIG. 1), the printer setting information print accepting means (2) 2 (FIG. 1), the printer setting information print formatting means 4 (FIG. 1), and the network setting information print formatting means 6 (FIG. 1) can be also constructed by a dedicated electronic circuit.

### Embodiment 2

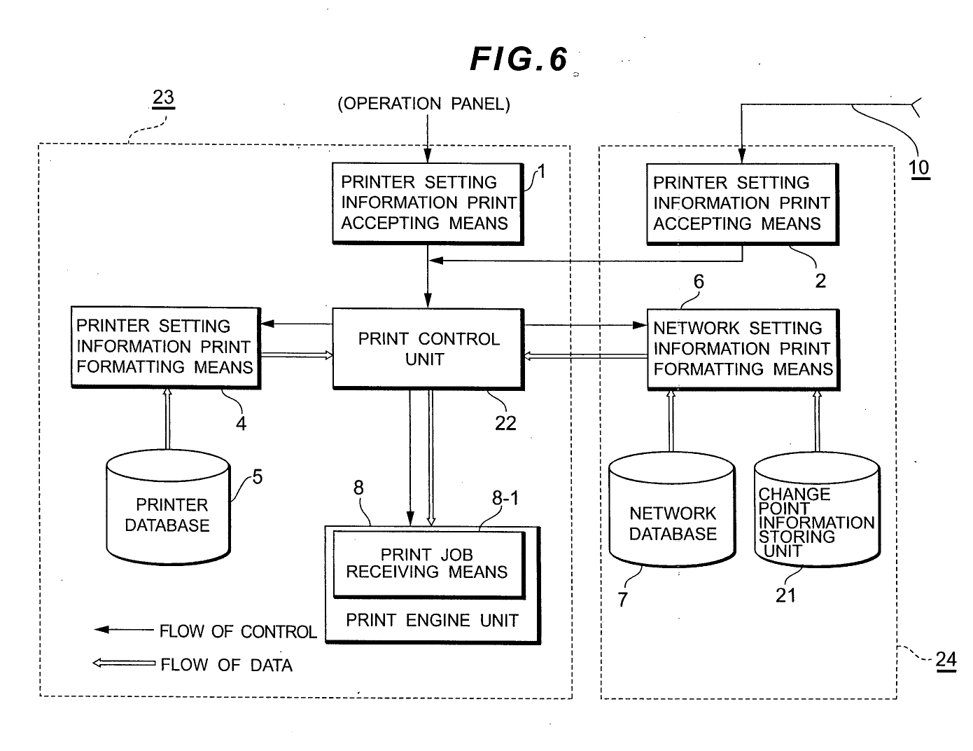

FIG. 6 is a block diagram of a construction in the embodiment 2.

Component elements similar to those in the embodiment 1 in the diagram are designated by the same reference numerals as those in the embodiment 1.

As shown in the diagram, a printer 23 of the embodiment 2 comprises: the printer setting information print accepting means (1) 1 which receives the print request of the set values that are inputted from the operation panel or the like of a printer main body; the printer setting information print accepting means (2) 2 which receives the print request of set values through the network 10 to which the printer 12 is connected; a print control unit 22 which deciphers the contents of the print request of the set values received from the printer setting information print accepting means (1) 1 or the printer setting information print accepting means (2) 2 and controls the printing process; the printer setting information print formatting means 4 which forms the print format of the set values regarding the printer on the basis of the control of the print control unit 22; and the printer database 5 which stores the set value of each setting item regarding the printer main body.

Further, the construction of the embodiment 2 comprises: the network setting information print formatting means 6 which forms the print format of the set values regarding the network on the basis of the control of the print control unit 22; the network database 7 which stores the set value of each setting item regarding the network 10; the print engine unit 8 which print-outputs predetermined set values on the basis of the control of the print control unit 22; and a change point information storing unit 21 which stores predetermined protocol information such as setting items or the like which are grouped together every protocol so that a plurality of setting items stored in the network database 7 are grouped together every related protocol and change point flag information showing the presence or absence of the set value change. The print engine unit 8 has the print job receiving means 8-1, therein, which receives the print job from the print control unit 22.

The network setting information print formatting means 6, the network database 7, and the change point information storing unit 9 are arranged in a network interface card 24 or the like which is used to connect the printer 23 to the network 10.

Ordinarily, in the print control unit 22, a CPU for controlling the whole printer 23 plays its role in accordance with a predetermined program. Further, the printer setting information print accepting means (1) 1, the printer setting information print accepting means (2) 2, the printer setting information print formatting means 4, the network setting information print formatting means 6, and the print job receiving means 8-1 are constructed by control means of the print control unit 22 which operates in accordance with the predetermined program. The predetermined program has been stored in the partial area in the ROM or RAM (not shown) in which the programs for controlling the whole printer have been stored.

The operation of the printer in the embodiment 2 will now be described.

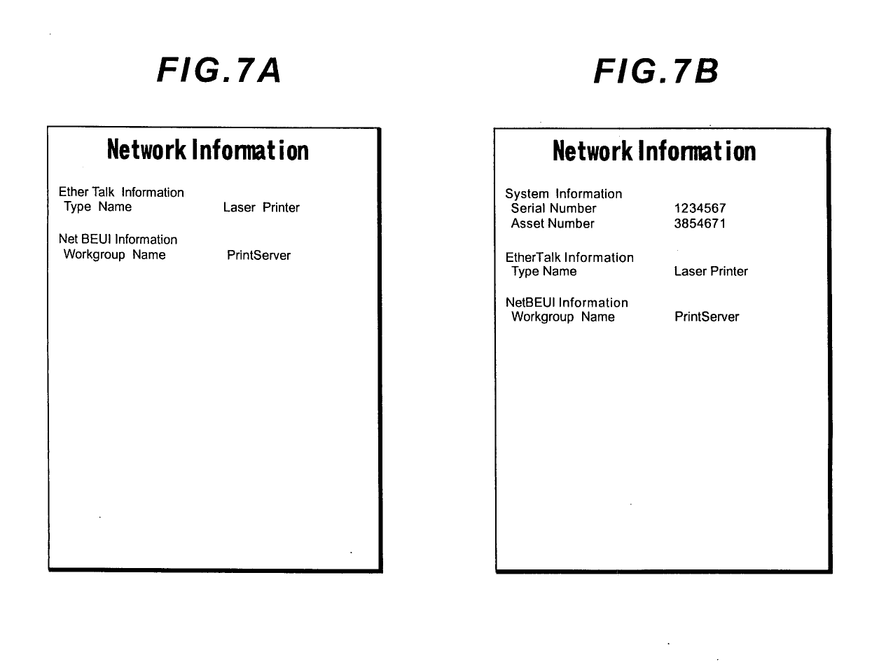

Prior to explaining the operation, the contents of the print-output of the set values will be described. FIGS. 7A and 7B show examples of the print-output of the set values in the embodiment 2.

The drawings show the examples of the diagrams each of which is obtained by print-outputting the changed set values. FIG. 7A shows the example in which the changed set values, their setting items, and the protocol in which the setting items are grouped together have been print-outputted. FIG. 7B shows the example in which “System Information” is print-outputted as a common item to the contents of FIG. 7A. This is because it is desirable to clarify by which printer the printing has been performed.

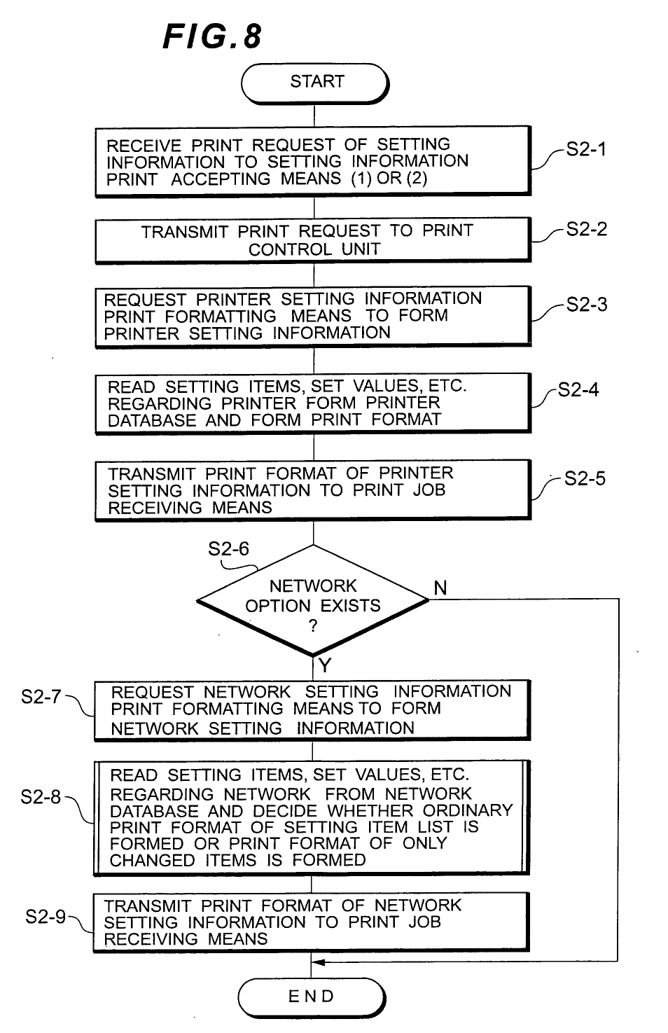

FIG. 8 is a flowchart for the whole operation of the printer in the embodiment 2.

This flowchart shows the operation which is executed until the print control unit 22 (FIG. 6) transmits the print format of printer setting information to the print engine unit 8 (FIG. 6) after it received the print-output request of the set values through the printer setting information print accepting means (1) 1 (FIG. 6) or the printer setting information print accepting means (2) 2 (FIG. 6). Processes in steps S2-1 to S2-9 will now be described in order of the processing steps. Step S2-1 The print-output request of the set values is inputted to the printer setting information print accepting means (1) 1 (FIG. 6) or the printer setting information print accepting means (2) 2 (FIG. 6). Information showing whether the printing of the conventional list is executed or the printing of the set values of only the change points is executed is included in the print-output request. Those information is inputted, for example, by a method whereby the network administrator selects predetermined selection items upon print-output requesting. At the same time, identification (ID) information to specify that the request is the print-output request is added to the print-output request.

Step S2-2

The print control unit 22 (FIG. 6) receives the print-output request of the set values through the printer setting information print accepting means (1) 1 (FIG. 6) or the printer setting information print accepting means (2) 2 (FIG. 6). On the basis of the ID information to specify that the request is the print-output request, the print control unit 22 (FIG. 6) recognizes here that the received signal is the print-output request of the set values.

Step S2-3

The print control unit 22 (FIG. 6) requests the printer setting information print formatting means 4 (FIG. 6) to form the printer setting information.

Step S2-4

On the basis of the control of the print control unit 22 (FIG. 6), the printer setting information print formatting means 4 (FIG. 6) obtains the setting items and their set values from the printer database 5 (FIG. 6), arranges them in order, forms the print format of the set values regarding the printer, and transmits the formed print format of the set values to the print control unit 22 (FIG. 6).

Step S2-5

The print control unit 22 (FIG. 6) transmits the print format of the set values regarding the printer which was received from the printer setting information print formatting means 4 (FIG. 6) to the print engine unit 8 (FIG. 6) through the print job receiving means 8-1. Further, prior to transmitting the print format of the set values regarding the printer, the print control unit 22 (FIG. 6) transmits the reception inhibiting command of another job to the print job receiving means 8-1 (FIG. 6). This is because it will be confused if another request (other than the print-output request of the set values) is issued between the print-output request of the set values regarding the printer and the subsequent print-output request of the set values regarding the network.

Step S2-6

The print control unit 22 (FIG. 6) discriminates whether or not the output request of the setting information regarding the network is included in the print-output request. If it is included, the processing routine advances to step S2-7. If it is not included, the processing routine is finished.

Step S2-7

The print control unit 22 (FIG. 6) requests the network setting information print formatting means 6 (FIG. 6) to form the print format of the set values regarding the network.

Step S2-8

On the basis of the control of the print control unit 22 (FIG. 6), the network setting information print formatting means 6 (FIG. 6) forms the print format of the setting information regarding the network on the basis of a predetermined method and transmits the formed print format of the set values to the print control unit 22 (FIG. 6). The predetermined method will be described in detail hereinafter with reference to other flowcharts. The predetermined method here is a method of printing with respect to the set values of only the change points.

Step S2-9

The print control unit 22 (FIG. 6) transmits the print format of the set values regarding the network received from the network setting information print formatting means 6 (FIG. 6) to the print engine unit 8 (FIG. 6) through the print job receiving means 8-1 and finishes the processing flow. Further, prior to transmitting the print format of the set values regarding the network, the print control unit 22 (FIG. 6) transmits the reception inhibition cancelling command of another job to the print job receiving means 8-1 (FIG. 6).

The predetermined method in step S2-8 mentioned above will now be described.

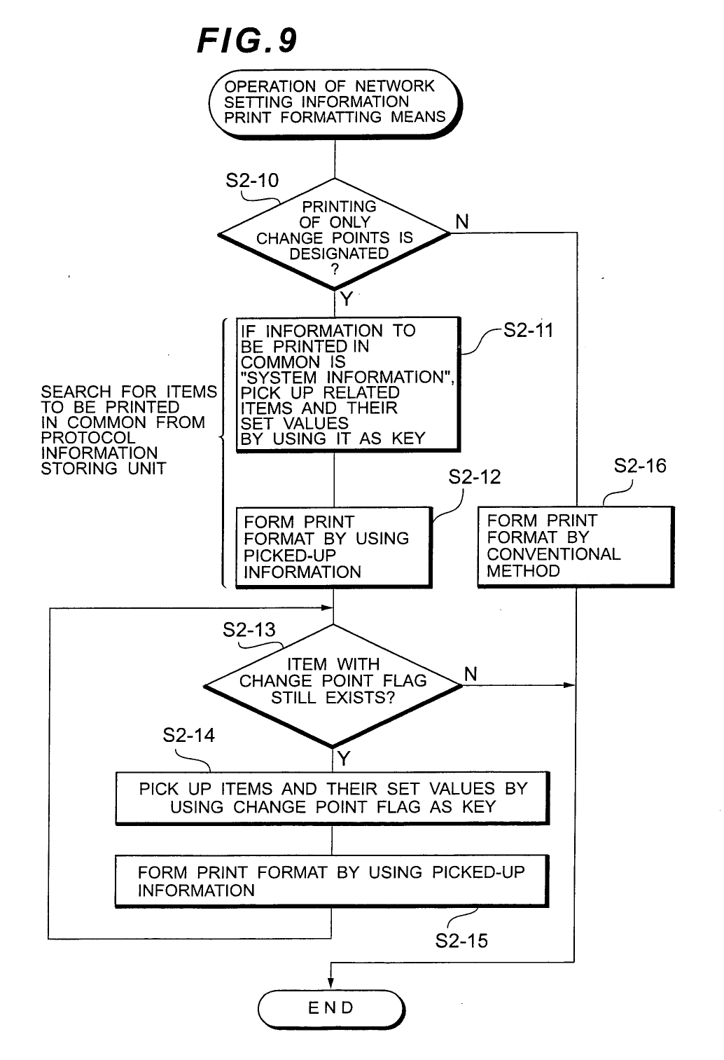

FIG. 9 is a flowchart for the operation of the network setting information print formatting means in the embodiment 2.

This diagram is the flowchart for describing the processing method in step S2-8 in detail. Processes in steps S2-10 to S2-16 will now be described in order of the processing steps.

Step S2-10

The print control unit 22 (FIG. 6) discriminates whether the received print-output request indicates the request of the print-output of the conventional setting item list or the print-output of only the change points is required. In the case of requesting the print-output of only the change points, step S2-11 follows. In the case of requesting the print-output of the conventional setting item list, step S2-16 follows. Those information is inputted, for example, by a method whereby the network administrator selects predetermined selection items upon print-output requesting in step S2-1.

Step S2-11

On the basis of the control of the print control unit 22 (FIG. 6), the network setting information print formatting means 6 (FIG. 6) obtains the setting items grouped together in “System Information” from the protocol information storing unit 9 (FIG. 6) by using “System Information” (an example), as a key, which is print-outputted in common with respect to all of the protocols and obtains the set values of those setting items from the network database 7 (FIG. 6).

Step S2-12

On the basis of the control of the print control unit 22 (FIG. 6), the network setting information print formatting means 6 (FIG. 6) forms the print format of “System Information” as a common item described with reference to FIG. 7 by using the obtained setting items and the set values.

Step S2-13

On the basis of the control of the print control unit 22 (FIG. 6), the network setting information print formatting means 6 (FIG. 6) searches for change point flag information stored in the change point information storing unit 21 (FIG. 6) and discriminates the presence or absence of the setting item whose set value has been changed. If the changed setting item exists, step S2-14 follows. If it does not exist, the processing flow is finished.

Step S2-14

On the basis of the control of the print control unit 22 (FIG. 6), the network setting information print formatting means 6 (FIG. 6) searches for the setting item whose set value has been changed and a category (including a protocol) related thereto and obtains the (changed) set value of this setting item from the network database 7 (FIG. 6) by using the detected setting item as a key.

Step S2-15

On the basis of the control of the print control unit 22 (FIG. 6), the network setting information print formatting means 6 (FIG. 6) adds the obtained set value of the setting item to a lower portion of the common item, thereafter, returns to step S2-13, searches for the change points, and repeats a loop comprising steps S2-14, S2-15, and S2-13. After all of the changed set values of the setting items were obtained, the processing routine advances out of the loop and the processing flow is finished.

Step S2-16

On the basis of the control of the print control unit 22 (FIG. 6), the network setting information print formatting means 6 (FIG. 6) forms the conventional print format in which all of the network related set values are listed and finishes the processing flow.

The information searching method in steps S2-11 and S2-14 will be described.

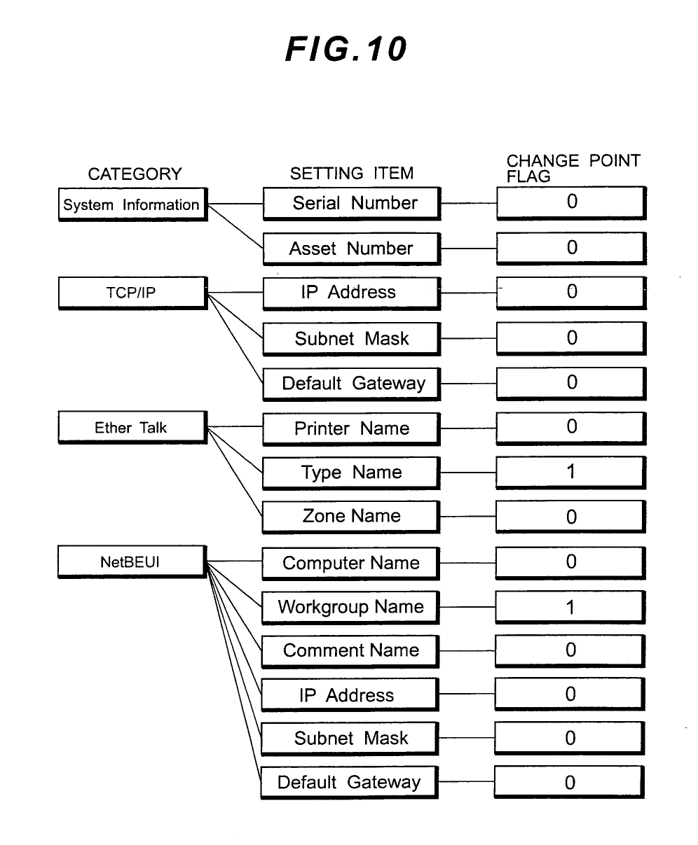

FIG. 10 is an explanatory diagram of the information searching method in the embodiment 2 (part 1).

This diagram is a diagram for explaining the method whereby on the basis of the control of the print control unit 22 (FIG. 6), the network setting information print formatting means 6 (FIG. 6) searches for the setting item whose set value has been changed by using change point flags stored in the change point information storing unit 21 (FIG. 6).

As shown in the diagram, when the network setting information print formatting means 6 (FIG. 6) sequentially examines the change point flags from the top of the diagram, the seventh flag from the top is at the high level (set to “1”). The 7th flag corresponds to the setting item “Type Name”. The setting item “Type Name” is grouped together to “Ether Talk”. Further, when the network setting information print formatting means 6 (FIG. 6) sequentially examines the change point flags from the top of the diagram, the tenth flag from the top is at the high level (set to “1”). The 10th flag corresponds to the setting item “Workgroup Name”. The setting item “Workgroup Name” is grouped together to “NetBEUI”. As mentioned above, on the basis of the control of print control unit 3 (FIG. 1), the network setting information print formatting means 6 (FIG. 6) can detect the changed setting items from the change point information storing unit 21 (FIG. 6).

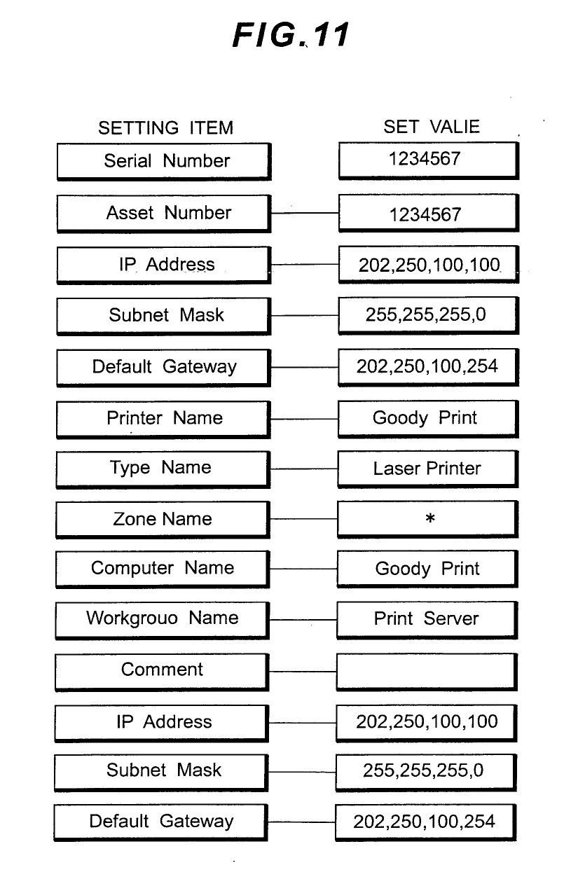

FIG. 11 is an explanatory diagram of the information searching method in the embodiment 2 (part 2).

This diagram is a diagram for explaining the method whereby on the basis of the control of the print control unit 22 (FIG. 6), the network setting information print formatting means 6 (FIG. 6) obtains the changed set value on the basis of the changed setting item detected from the change point information storing unit 21 (FIG. 6).

The set value of the changed setting item “Type Name (column on the left side of the diagram) obtained in FIG. 11 mentioned above is obtained as “Laser Printer” (column on the right side of the diagram). Similarly, the set value of the changed setting item “Workgroup Name (column on the left side of the diagram) is obtained as “Print Server” (column on the right side of the diagram).

Therefore, the network setting information print formatting means 6 (FIG. 6) searches for the setting item whose set value has been changed by using the change point flags stored in the change point information storing unit 21 (FIG. 6), searches the network database 7 (FIG. 6) on the basis of the search result, and detects the changed set value. The category and setting items detected as mentioned above and the changed set values are arranged as shown in FIG. 7 and print-outputted.

As described above, in the embodiment, since only the set value of the changed setting item is print-outputted, an effect that the time and attention to detect the necessary information can be saved is obtained. Further, an effect that wastefulness of consumables can be avoided is also obtained.

Although the invention has been described above on the assumption that all of the printer setting information print accepting means (1) 1 (FIG. 6), the printer setting information print accepting means (2) 2 (FIG. 6), the printer setting information print formatting means 4 (FIG. 6), and the network setting information print formatting means 6 (FIG. 6) are constructed by the control means of the print control unit 22 (FIG. 6), the invention is not limited to this example. That is, all or a part of the printer setting information print accepting means (1) 1 (FIG. 6), the printer setting information print accepting means (2) 2 (FIG. 6), the printer setting information print formatting means 4 (FIG. 6), and the network setting information print formatting means 6 (FIG. 6) can be also constructed by a dedicated electronic circuit.

Further, although the change point flag information has been stored in the change point information storing unit 21 (FIG. 6) in the above description, the invention is not limited to this example. That is, the invention is not limited to the change point flag information but any information can be used so long as it can hold a fact that the set value has been changed.

### Embodiment 3

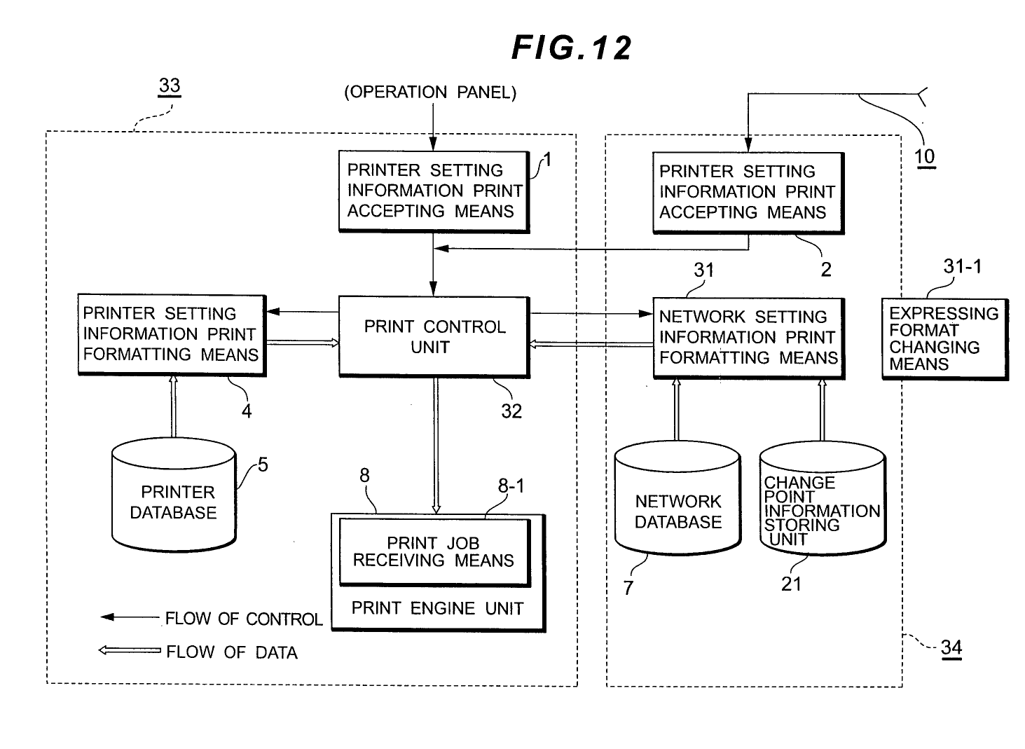

FIG. 12 is a block diagram of a construction in the embodiment 3.

Component elements similar to those in the embodiment 2 in the diagram are designated by the same reference numerals as those in the embodiment 2.

As shown in the diagram, a printer 33 of the embodiment 3 comprises: the printer setting information print accepting means (1) 1 which receives the print request of the set values that are inputted from the operation panel or the like of a printer main body; the printer setting information print accepting means (2) 2 which receives the print request of set values through the network 10 to which the printer 12 is, connected; a print control unit 32 which deciphers the contents of the print-output request of the set values received from the printer setting information print accepting means (1) 1 or the printer setting information print accepting means (2) 2 and controls the printing process; the printer setting information print formatting means 4 which forms the print format of the set values regarding the printer on the basis of the control of the print control unit 32; and the printer database 5 which stores the set value of each setting item regarding the printer main body.

Further, the construction of the embodiment 3 comprises: network setting information print formatting means 31 which forms the print format of the set values regarding the network on the basis of the control of the print control unit 32; the network database 7 which stores the set value of each setting item regarding the network 10; the print engine unit 8 which print-outputs predetermined set values on the basis of the control of the print control unit 32; and the change point information storing unit 21 which stores the predetermined protocol information such as setting items or the like which are grouped together every protocol so that a plurality of setting items stored in the network database 7 are grouped together every related protocol and the change point flag information showing the presence or absence of the set value change. The network setting information print formatting means 31 has expressing format changing means 31-1, therein, which changes an expressing format in the print-output of the set values on the basis of predetermined conditions. The print engine unit 8 has the print job receiving means 8-1, therein, which receives the print job from the print control unit 32.

The network setting information print formatting means 31, the network database 7, and the change point information storing unit 21 are arranged in a network interface card 34 or the like which is used to connect the printer 33 to the network 10.

Ordinarily, in the print control unit 32, a CPU for controlling the whole printer 33 plays its role in accordance with a predetermined program. Further, the printer setting information print accepting means (1) 1, the printer setting information print accepting means (2) 2, the printer setting information print formatting means 4, the network setting information print formatting means 31, and the print job receiving means 8-1 are constructed by control means of the print control unit 32 which operates in accordance with the predetermined program. The predetermined program has been stored in the partial area in the ROM or RAM (not shown) in which the programs for controlling the whole printer have been stored.

The operation of the printer in the embodiment 3 will now be described.

Prior to explaining the operation, the contents of the print-output of the set values will be described.

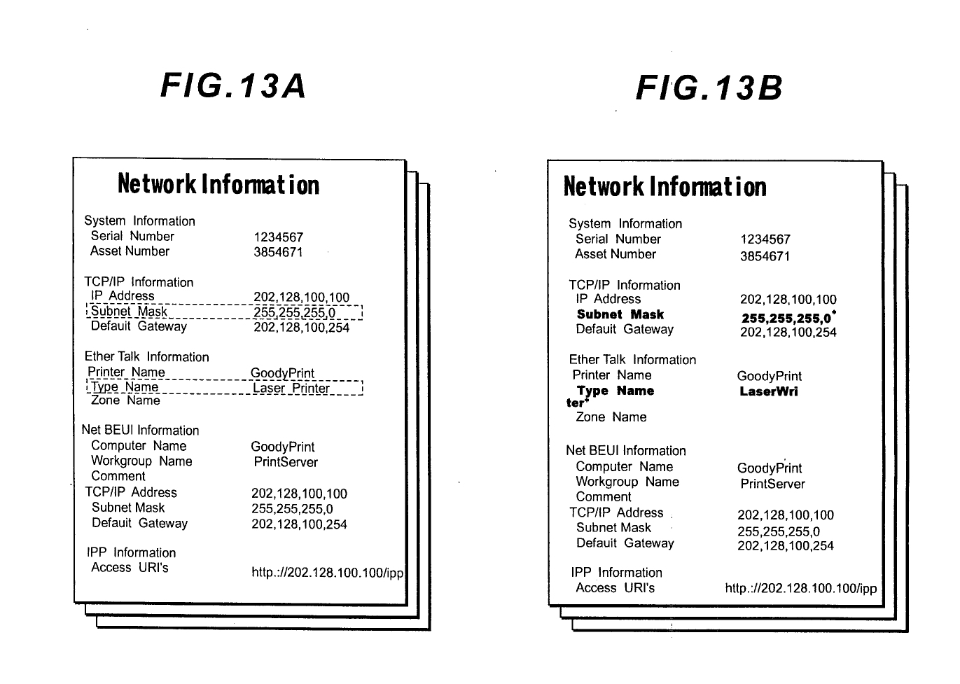

FIGS. 13A and 13B show examples of the print-output of the set values in the embodiment 3.

FIG. 13A shows the example in which only the set values of the changed setting items in a set value list are shown in a color different from that used in the printing of other items. It is now assumed that an area in a frame shown by a broken line is printed in another color. FIG. 13B shows the example in which only the set values of the changed setting items in a set value list are shown by bold characters.

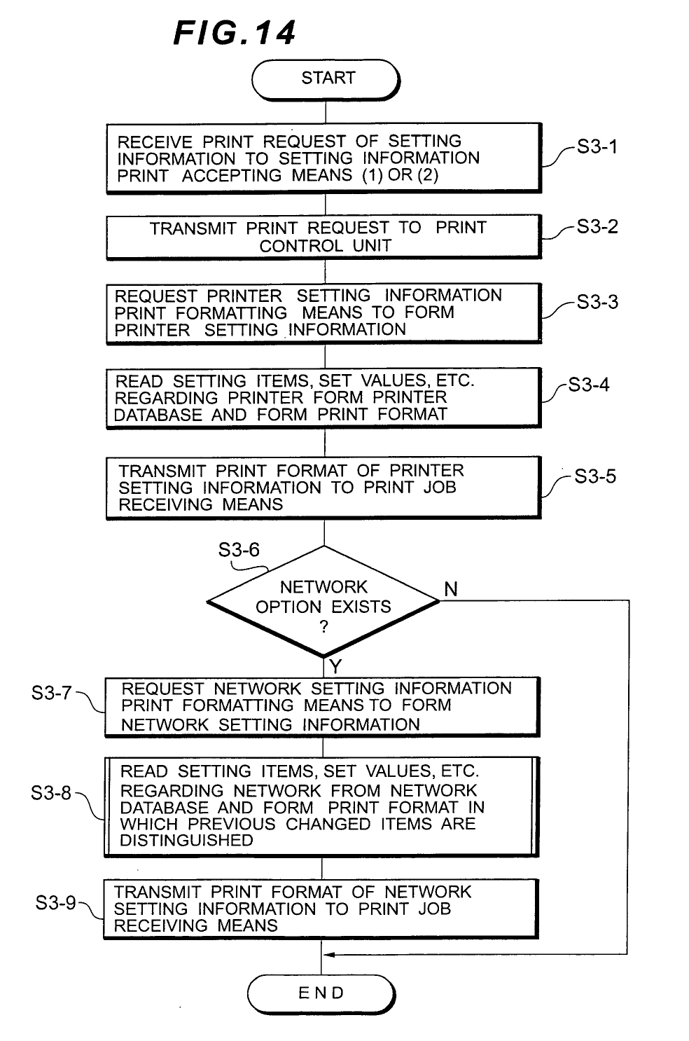

FIG. 14 is a flowchart for the whole operation of the printer in the embodiment 3.

This flowchart shows the operation which is executed until the print control unit 32 (FIG. 12) transmits the print format of printer setting information to the print engine unit 8 (FIG. 12) after it received the print-output request of the set values through the printer setting information print accepting means (1) 1 (FIG. 12) or the printer setting information print accepting means (2) 2 (FIG. 12). Processes in steps S3-1 to S3-9 will now be described in order of the processing steps.

Step S3-1

The print-output request of the set values is inputted to the printer setting information print accepting means (1) 1 (FIG. 12) or the printer setting information print accepting means (2) 2 (FIG. 12). Information showing whether the printing of the conventional list is executed or the printing is executed by changing the expressing format of the set values of only the change points in the list is included in the print-output request. Those information is inputted, for example, by a method whereby the network administrator selects predetermined selection items upon print-output requesting. At the same time, identification (ID) information to specify that the request is the print-output request is added to the print-output request.

Step S3-2

The print control unit 32 (FIG. 12) receives the print-output request of the set values through the printer setting information print accepting means (1) 1 (FIG. 12) or the printer setting information print accepting means (2) 2 (FIG. 12). On the basis of the ID information to specify that the request is the print-output request, the print control unit 32 (FIG. 12) recognizes here that the received signal is the print-output request of the set values.

Step S3-3

The print control unit 32 (FIG. 12) requests the printer setting information print formatting means 4 (FIG. 12) to form the printer setting information.

Step S3-4

On the basis of the control of the print control unit 32 (FIG. 12), the printer setting information print formatting means 4 (FIG. 12) obtains the setting items and their set values from the printer database 5 (FIG. 12), arranges them in order, forms the print format of the set values regarding the printer, and transmits the formed print format of the set values to the print control unit 32 (FIG. 12).

Step S3-5

The print control unit 32 (FIG. 12) transmits the print format of the set values regarding the printer which was received from the printer setting information print formatting means 4 (FIG. 12) to the print engine unit 8 (FIG. 12) through the print job receiving means 8-1 (FIG. 12). Further, prior to transmitting the print format of the set values regarding the printer, the print control unit 32 (FIG. 12) transmits the reception inhibiting command of another job to the print job receiving means 8-1 (FIG. 12). This is because it will be confused if another request (other than the print-output request of the set values) is issued between the print-output request of the set values regarding the printer and the subsequent print-output request of the set values regarding the network.

Step S3-6

The print control unit 32 (FIG. 12) discriminates whether or not the output request of the setting information regarding the network is included in the print-output request. If it is included, the processing routine advances to step S3-7. If it is not included, the processing routine is finished.

Step S3-7

The print control unit 32 (FIG. 12) requests the network setting information print formatting means 31 (FIG. 12) to form the print format of the set values regarding the network.

Step S3-8

On the basis of the control of the print-control unit 32 (FIG. 12), the network setting information print formatting means 31 (FIG. 12) forms the print format of the set values regarding the network on the basis of a predetermined method and transmits the formed print format of the set values to the print control unit 32 (FIG. 12). The predetermined method will be described in detail hereinafter with reference to other flowcharts. The predetermined method here is a method whereby the expressing format of only the change points is changed on the list and the printing is executed.

Step S3-9

The print control unit 32 (FIG. 12) transmits the print format of the set values regarding the network received from the network setting information print formatting means 31 (FIG. 12) to the print engine unit 8 (FIG. 12) through the print job receiving means 8-1 (FIG. 12) and finishes the processing flow. Further, prior to transmitting the print format of the set values regarding the network, the print control unit 32 (FIG. 12) transmits the reception inhibition cancelling command of another job to the print job receiving means 8-1 (FIG. 12).

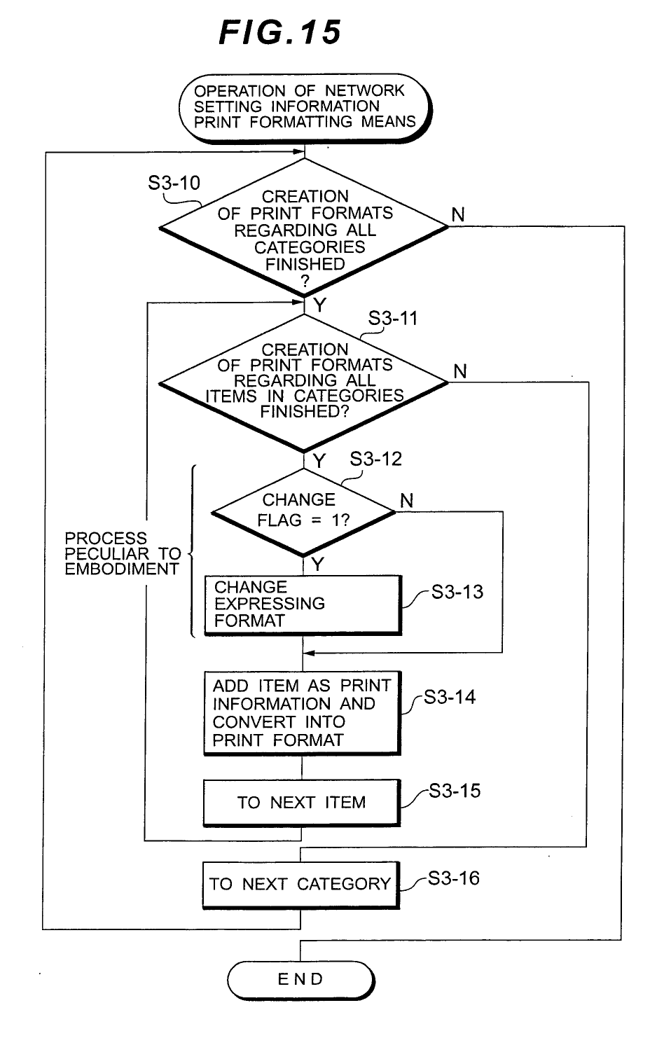

The predetermined method in step S3-8 mentioned above will now be described. FIG. 15 is a flowchart for the operation of the network setting information print formatting means in the embodiment 3.

This diagram is the flowchart for describing the processing method in step S3-8 in detail. Processes in steps S3-10 to S3-16 will now be described in order of the processing steps.

Step S3-10

On the basis of the control of the print control unit 32 (FIG. 12), the network setting information print formatting means 31 (FIG. 12) sequentially (that is, in storing order) obtains categories (including protocols) stored in the change point information storing unit 21 (FIG. 12), forms the print format, and advances to step S3-11. If the creation of the print formats is finished with respect to all of the categories, the processing flow is finished.

Step S3-11

On the basis of the control of the print control unit 32 (FIG. 12), the network setting information print formatting means 31 (FIG. 12) obtains the setting items regarding the categories (including the protocols) obtained in step S3-10 and advances to step S3-12. If the creation of the print formats of all of the setting items is finished, step S3-16 follows.

Step S3-12

On the basis of the control of the print control unit 32 (FIG. 12), the network setting information print formatting means 31 (FIG. 12) advances to step S3-13 if the flag of each of the obtained setting items is at the high level (set to “1”). If the flag of each of the obtained setting items is at the low level (set to “0”), the processing routine jumps to step S1-14.

Step S3-13

On the basis of the control of the print control unit 32 (FIG. 12), the network setting information print formatting means 31 (FIG. 12) converts the expressing format by the expressing format changing means 31-1 (FIG. 12).

Step S3-14

On the basis of the control of the print control unit 32 (FIG. 12), the network setting information print formatting means 31 (FIG. 12) forms the print format.

Step S3-15

On the basis of the control of the print control unit 32 (FIG. 12), the network setting information print formatting means 31 (FIG. 12) searches for the next setting item and returns to step S3-11.

Step S3-16

On the basis of the control of the print control unit 32 (FIG. 12), the network setting information print formatting means 31 (FIG. 12) searches for the next category and returns to step S3-10.

The information searching method in steps S3-10 to 3-16 will now be described.

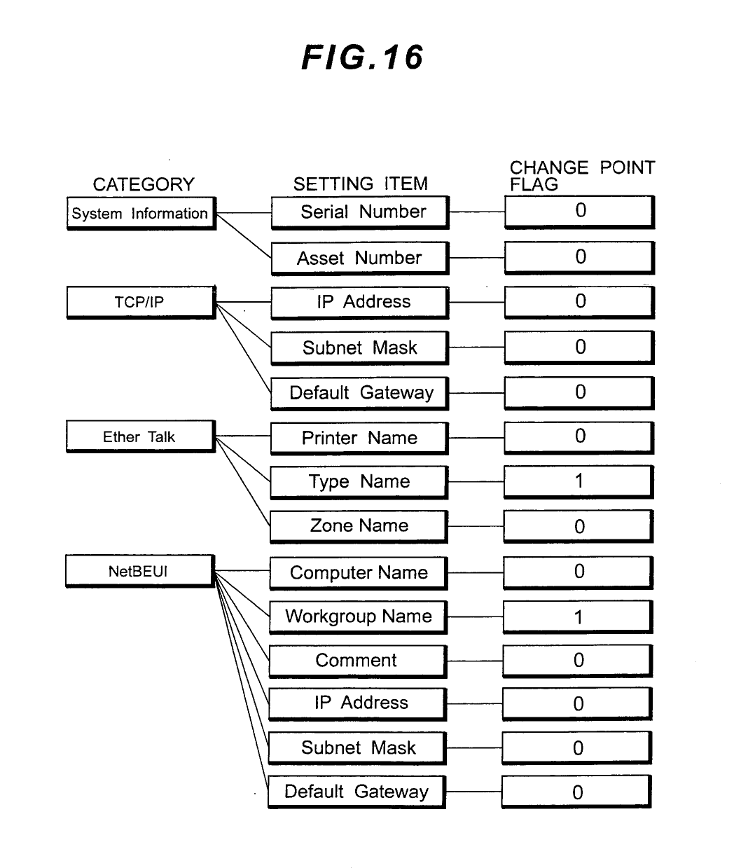

FIG. 16 is an explanatory diagram of the information searching method in the embodiment 3 (part 1).

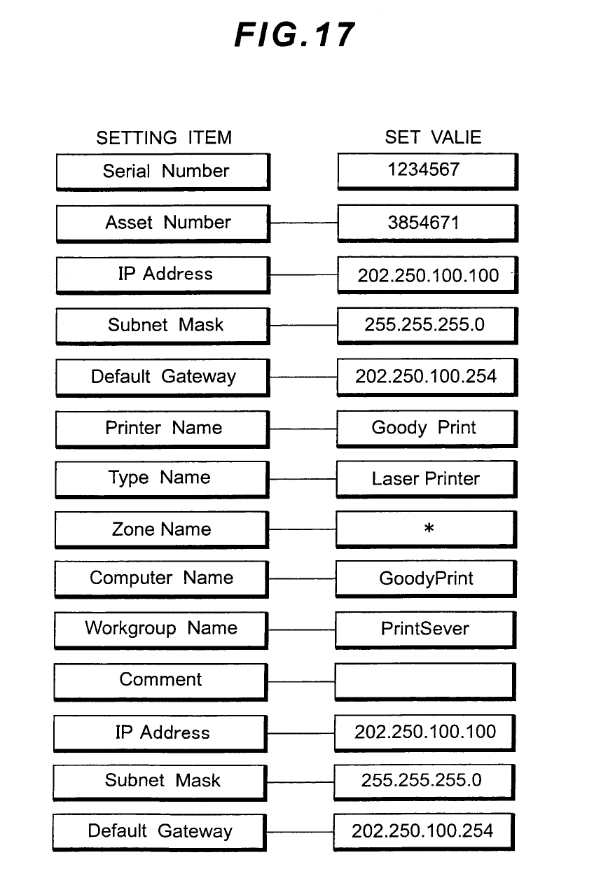

FIG. 17 is an explanatory diagram of the information searching method in the embodiment 3 (part 2).

Those diagrams are diagrams for explaining the method whereby on the basis of the control of the print control unit 32 (FIG. 12), the network setting information print formatting means 31 (FIG. 12) forms a print format of a set value list in which only the setting items whose change point flags stored in the change point information storing unit 21 (FIG. 12) are equal to “1” are expressed in another expressing format.

As shown in the diagrams, the network setting information print formatting means 31 (FIG. 12) sequentially (that is, in storing order) obtains the categories stored in the change point information storing unit 21 (FIG. 12) from the top of FIG. 16. Subsequently, the formatting means 31 sequentially obtains the setting items included in such categories from the top of FIG. 16. The formatting means 31 obtains the set values of the setting items from the network database 7 (FIG. 12) on the basis of FIG. 17, and forms the print format. At this time, if the flags of the setting items are equal to “1” (“Type Name” and “Workgroup Name” in FIG. 16 correspond to them), the expressing format is changed by the expressing format changing means 31-1 (FIG. 12) and the print format is formed. The print formats are formed with respect to all of the categories and all of the setting items as mentioned above. Thus, as shown in FIGS. 13A and 13B, the set value list in which only the setting items whose set values have been changed are expressed in the expressing format different from the expressing format in which other items have been printed.

As described above, according to the embodiment, since the set value list in which only the setting items whose set values have been changed are expressed in the expressing format different from the expressing format in which other items have been printed, an effect that the time and attention to detect the necessary information can be saved is obtained.

Although the invention has been described above on the assumption that all of the printer setting information print accepting means (1) 1 (FIG. 12), the printer setting information print accepting means (2) 2 (FIG. 12), the printer setting information print formatting means 4 (FIG. 12), the network setting information print formatting means 31 (FIG. 12), and the expressing format changing means 31-1 (FIG. 12) are constructed by the control means of the print control unit 32 (FIG. 12), the invention is not limited to this example. That is, all or a part of the printer setting information print accepting means (1) 1 (FIG. 12), the printer setting information print accepting means (2) 2 (FIG. 12), the printer setting information print formatting means 4 (FIG. 12), the network setting information print formatting means 31 (FIG. 12), and the expressing format changing means 31-1 (FIG. 12) can be also constructed by a dedicated electronic circuit.

Further, although it is assumed in the above description that the change point flag information has been stored in the change point information storing unit 21 (FIG. 12), the invention is not limited to such an example. That is, the invention is not limited to the change point flag information but any information can be used so long as it can hold a fact that the set value has been changed. Although the case where only the color and the font type are used as different expressing formats has been described above, the invention is not limited to such an example. That is, another expressing format in which a specific code is added or the like can be also used.

### Embodiment 4

In the setting items in FIG. 2 described in the embodiment 1, in the categories of “TCP/IP Information” and “NetBEUI Information”, three setting items of “IP Address”, “Subnet Mask” and “Default Gateway” are overlapped. Therefore, in the embodiment 2, if “TCP/IP Address” of the “TCP/IP Information” category is merely changed, the “TCP/IP Address” of the “NetBEUI Information” category is not print-outputted as a change point.

In the case of “Printer Name” of the “Ether Talk (Information)” category and “Computer Name” of the “NetBEUI Information” category, although the setting item names are different, their set values are common. In this case, in the above embodiment 2, if one of them is merely changed, the other is not print-outputted as a change point. The embodiment intends to solve such an inconvenient point.

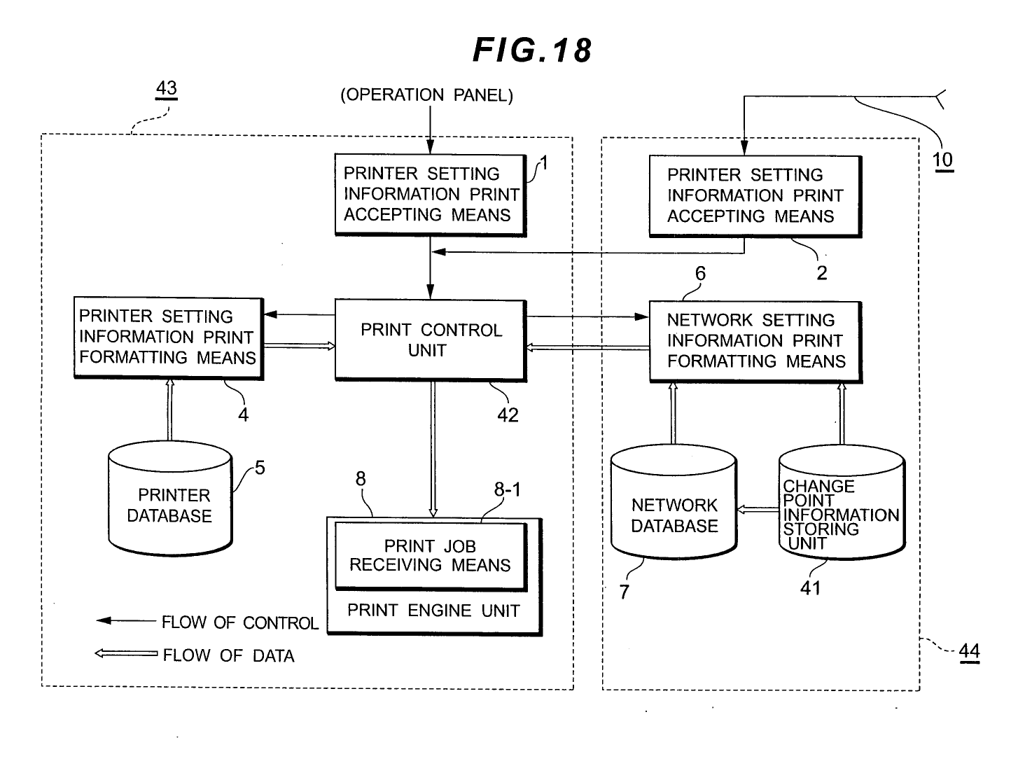

FIG. 18 is a block diagram of a construction in the embodiment 4.

Component elements similar to those in the embodiment 2 in the diagram are designated by the same reference numerals as those in the embodiment 2.

As shown in the diagram, a printer 43 of the embodiment 4 comprises: the printer setting information print accepting means (1) 1 which receives the print request of the set values that are inputted from the operation panel or the like of a printer main body; the printer setting information print accepting means (2) 2 which receives the print request of set values through the network 10 to which the printer 12 is connected; a print control unit 42 which deciphers the contents of the print request of the set values received from the printer setting information print accepting means (1) 1 or the printer setting information print accepting means (2) 2 and controls the printing process; the printer setting information print formatting means 4 which forms the print format of the set values regarding the printer on the basis of the control of the print control unit 42; and the printer database 5 which stores the set value of each setting item regarding the printer main body.

Further, the construction of the embodiment 4 comprises: the network setting information print formatting means 6 which forms the print format of the set values regarding the network on the basis of the control of the print control unit 42; the network database 7 which stores the set value of each setting item regarding the network 10; the print engine unit 8 which print-outputs predetermined set values on the basis of the control of the print control unit 42; and a change point information storing unit 41 which stores the predetermined protocol information such as setting items or the like which are grouped together every protocol so that a plurality of setting items stored in the network database 7 are grouped together every related protocol and the change point flag information showing the presence or absence of the set value change. Information in which one setting item is grouped together to a plurality of categories and information in which although the names of the setting items are different, their set values are identical are also included in the protocol information. The print engine unit 8 has the print job receiving means 8-1, therein, which receives the print job from the print control unit 42.

The network setting information print formatting means 6, the network database 7, and the change point information storing unit 41 are arranged in a network interface card 44 or the like which is used to connect the printer 43 to the network 10.

Ordinarily, in the print control unit 42, a CPU for controlling the whole printer 43 plays its role in accordance with a predetermined program. Further, the printer setting information print accepting means (1) 1, the printer setting information print accepting means (2) 2, the printer setting information print formatting means 4, the network setting information print formatting means 6, and the print job receiving means 8-1 are constructed by control means of the print control unit 42 which operates in accordance with the predetermined program. The predetermined program has been stored in the partial area in the ROM or RAM (not shown) in which the programs for controlling the whole printer have been stored.

The operation of the printer in the embodiment 4 will now be described.

Prior to explaining the operation, the contents of the print-output of the set values will be described.

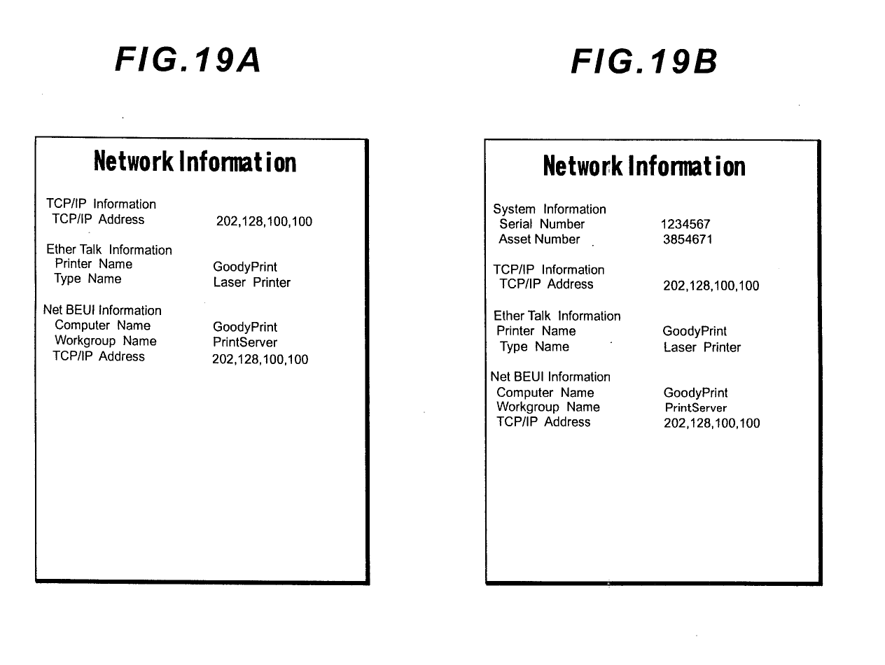

FIGS. 19A and 19B show examples of the print-output of the set values in the embodiment 4.

FIG. 19A shows the example of the diagram in which the changed set values have been print-outputted and shows the example in which the changed set values, their setting items, and a protocol by which the setting items are grouped together are print-outputted.

FIG. 19B shows the example in which “System Information” is print-outputted as a common item to the contents of FIG. 19A. This is because it is desirable to clarify by which printer they have been printed.

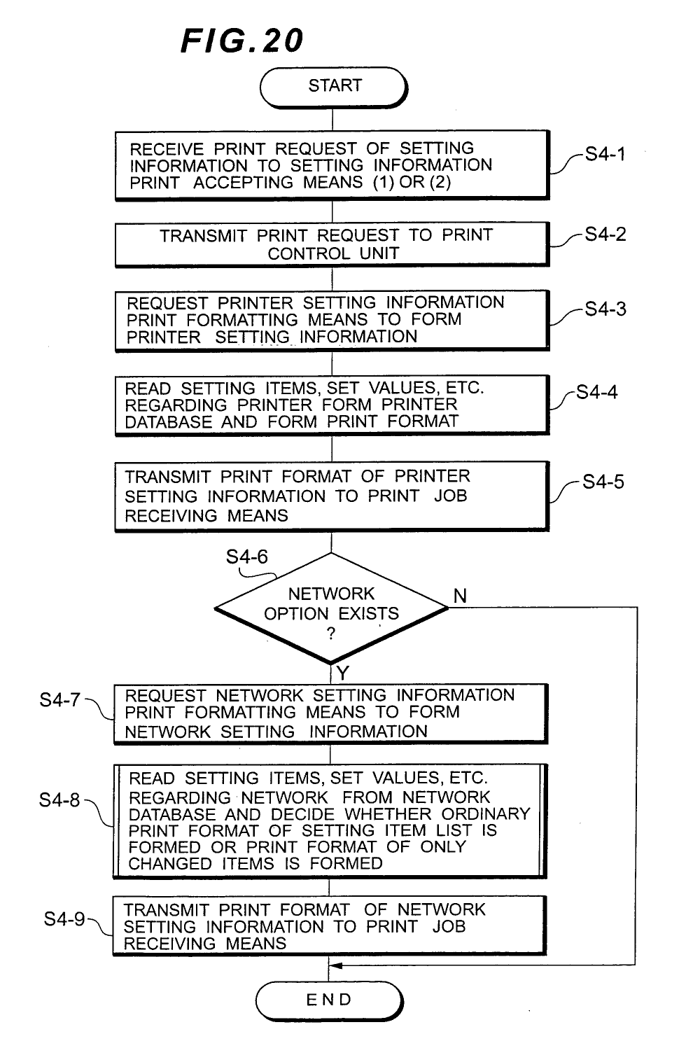

FIG. 20 is a flowchart for the whole operation of the printer in the embodiment 4.

This flowchart shows the operation which is executed until the print control unit 42 (FIG. 18) transmits the print format of printer setting information to the print engine unit 8 (FIG. 18) after it received the print-output request of the set values through the printer setting information print accepting means (1) 1 (FIG. 18) or the printer setting information print accepting means (2) 2 (FIG. 18). Processes in steps S4-1 to S4-9 will now be described in order of the processing steps.

Step S4-1

The print-output request of the set values is inputted to the printer setting information print accepting means (1) 1 (FIG. 18) or the printer setting information print accepting means (2) 2 (FIG. 18). Information showing whether the printing of the conventional list is executed or the printing of only the change points is executed is included in the print-output request. Those information is inputted, for example, by a method whereby the network administrator selects predetermined selection items upon print-output requesting. At the same time, identification (ID) information to specify that the request is the print-output request is added to the print-output request.

Step S4-2

The print control unit 42 (FIG. 18) receives the print-output request of the set values through the printer setting information print accepting means (1) 1 (FIG. 18) or the printer setting information print accepting means (2) 2 (FIG. 18). On the basis of the ID information to specify that the request is the print-output request, the print control unit 42 (FIG. 18) recognizes here that the received signal is the print-output request of the set values.

Step S4-3

The print control unit 42 (FIG. 12) requests the printer setting information print formatting means 4 (FIG. 18) to form the printer setting information.

Step S4-4

On the basis of the control of the print control unit 42 (FIG. 18), the printer setting information print formatting means 4 (FIG. 18) obtains the setting items and their set values from the printer database 5 (FIG. 18), arranges them in order, forms the print format of the set values regarding the printer, and transmits the formed print format of the set values to the print control unit 42 (FIG. 18).

Step S4-5

The print control unit 42 (FIG. 18) transmits the print format of the set values regarding the printer which was received from the printer setting information print formatting means 4 (FIG. 18) to the print engine unit 8 (FIG. 18) through the print job receiving means 8-1 (FIG. 18). Further, prior to transmitting the print format of the set values regarding the printer, the print control unit 42 (FIG. 18) transmits the reception inhibiting command of another job to the print job receiving means 8-1 (FIG. 18). This is because it will be confused if another request (other than the print-output request of the set values) is issued between the print-output request of the set values regarding the printer and the subsequent print-output request of the set values regarding the network.

Step S4-6

The print control unit 42 (FIG. 18) discriminates whether or not the output request of the setting information regarding the network is included in the print-output request. If it is included, the processing routine advances to step S4-7. If it is not included, the processing routine is finished.

Step S4-7

The print control unit 42 (FIG. 18) requests the network setting information print formatting means 6 (FIG. 18) to form the print format of the set values regarding the network.

Step S4-8

On the basis of the control of the print control unit 42 (FIG. 18), the network setting information print formatting means 6 (FIG. 18) forms the print format of the setting information regarding the network on the basis of a predetermined method and transmits the formed print format of the set values to the print control unit 42 (FIG. 18). The predetermined method will be described in detail hereinafter with reference to other flowcharts. The predetermined method is a printing method of the set values of only the change points and is a printing method in the case where the set value is common to a plurality of setting items and the case where although the names of the setting items are different, the set values are identical.

Step S4-9

The print control unit 42 (FIG. 18) transmits the print format of the set values regarding the network received from the network setting information print formatting means 6 (FIG. 18) to the print engine unit 8 (FIG. 18) through the print job receiving means 8-1 (FIG. 18) and finishes the processing flow. Further, prior to transmitting the print format of the set values regarding the network, the print control unit 42 (FIG. 18) transmits the reception inhibition cancelling command of another job to the print job receiving means 8-1 (FIG. 18).

The predetermined method in step S4-8 mentioned above will now be described.

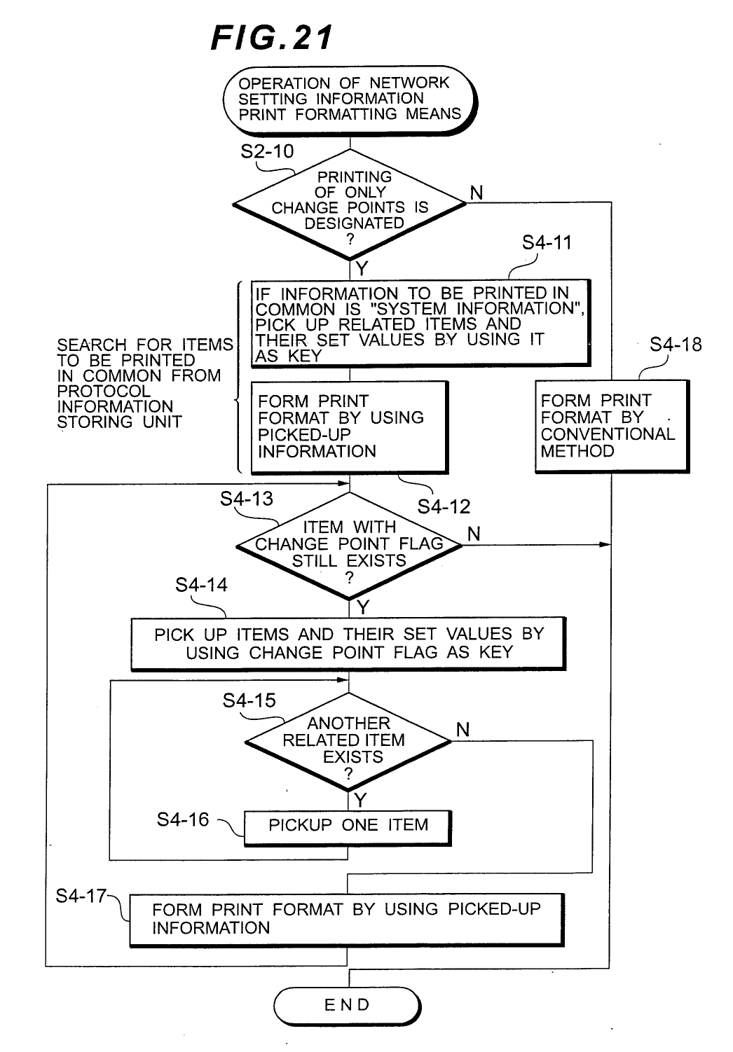

FIG. 21 is a flowchart for the operation of the network setting information print formatting means in the embodiment 4.

This diagram is the flowchart for describing the processing method in step S4-8 in detail. Processes in steps S4-10 to S4-18 will now be described in order of the processing steps.

Step S4-10

The print control unit 42 (FIG. 18) discriminates whether the received print-output request desires the conventional print-output of the setting item list or desires the print-output of only the change points. If it desires the print-output of only the change points, step S4-11 follows. If it desires the conventional print-output of the setting item list, step S4-18 follows. Those information is inputted, for example, by a method whereby the network administrator selects predetermined selection items when he requests the print-output in step S4-1 mentioned above.

Step S4-11

On the basis of the control of the print control unit 42 (FIG. 18), the network setting information print formatting means 6 (FIG. 18) obtains the setting items which are grouped together in “System Information” from the protocol information storing unit 9 (FIG. 18) by using “System Information” (an example), as a key, which is print-outputted in common with respect to all of the protocols and obtains the set values of those setting items from the network database 7 (FIG. 18).

Step S4-12

On the basis of the control of the print control unit 42 (FIG. 18), the network setting information print formatting means 6 (FIG. 18) forms the print format of “System Information” as a common item described with reference to FIGS. 19A and 19B by using the obtained setting items and the set values.

Step S4-13

On the basis of the control of the print control unit 42 (FIG. 18), the network setting information print formatting means 6 (FIG. 18) searches for the change point flag information stored in the change point information storing unit 41 (FIG. 18) and discriminates the presence or absence of the setting item whose set value has been changed. If the setting item whose set value has been changed exists, step S4-14 follows. If it does not exist, the processing flow is finished.

Step S4-14

On the basis of the control of the print control unit 42 (FIG. 18), the network setting information print formatting means 6 (FIG. 18) searches for the setting item whose set value has been changed and the category (including the protocol) related thereto and obtains the (changed) set value of this setting item from the network database 7 (FIG. 18) by using the detected setting item as a key.

Step S4-15

On the basis of the control of the print control unit 42 (FIG. 18), the network setting information print formatting means 6 (FIG. 18) searches for the setting item whose set value has been changed and another category (including the protocol) related thereto. If they exist, step S4-16 follows. If they do not exist, step S4-17 follows.

Step S4-16

On the basis of the control of the print control unit 42 (FIG. 18), the network setting information print formatting means 6 (FIG. 18) searches for the setting item whose set value has been changed and another category (including the protocol) related thereto and obtains the (changed) set value of this setting item from the network database 7 (FIG. 18) by using the detected setting item as a key. Further, the processing routine is returned to step S4-15 in order to search for another related category (including the protocol).

Step S4-17

On the basis of the control of the print control unit 42 (FIG. 18), the network setting information print formatting means 6 (FIG. 18) adds the obtained set value of the setting item to a lower portion of the common item, thereafter, returns to step S4-13, searches for the change points, and repeats a loop comprising steps S4-14 to S4-17. After all of the changed set values of the setting items were obtained, the processing routine advances out of the loop and the processing flow is finished.

Step S4-18

On the basis of the control of the print control unit 42 (FIG. 6), the network setting information print formatting means 6 (FIG. 18) forms the conventional print format in which all of the network related set values are listed and finishes the processing flow.

The information searching method in steps S4-11 and S4-14 will be described.

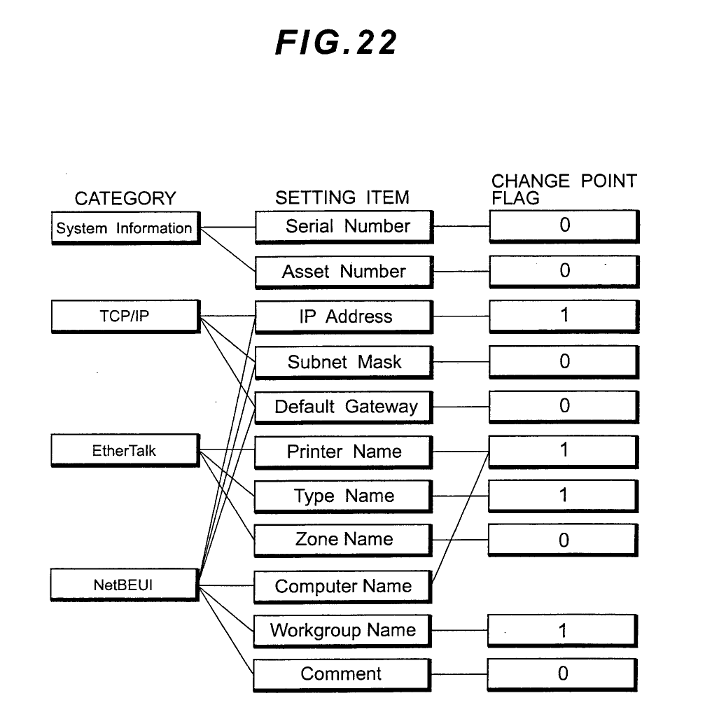

FIG. 22 is an explanatory diagram of the information searching method in the embodiment 4 (part 1).

This diagram is a diagram for explaining the method whereby on the basis of the control of the print control unit 42 (FIG. 18), the network setting information print formatting means 6 (FIG. 18) searches for the setting item whose set value has been changed by using change point flags stored in the change point information storing unit 41 (FIG. 18).

In FIG. 10 in the embodiment 2 which has already been described, one setting item is not grouped together to a plurality of categories. In FIG. 22, however, one setting item is grouped together to a plurality of categories. For example, “IP Address”, “Subnet Mask”, and “Default Gateway” in the diagram can be mentioned. Although a plurality of setting items do not use one change point flag in common in FIG. 10, a plurality of setting items use one change point flag in common in FIG. 22. For example, “Printer Name” and “Computer Name” in the diagram can be mentioned.

As shown in the diagram, when the network setting information print formatting means 6 (FIG. 18) examines the change point flags in order from the top of the diagram, the third flag from the top is at the high level (set to “1”). The 3rd flag corresponds to the setting item “IP Address”. The setting item “IP Address” is grouped together to “TCP/IP” and “NetBEUI”. Therefore, first, the network setting information print formatting means 6 (FIG. 18) searches for the set values in the category “TCP/IP” (step S4-14), after that, searches for the set values in “NetBEUI” (step S4-16), and obtains the same set value.

Similarly, when the network setting information print formatting means 6 (FIG. 18) examines the change point flags in order from the top of the diagram, the sixth flag from the top is at the high level (set to “1”). The 6th flag is used in common by the setting items “Printer Name” and “Computer Name”. This means that although the names of the setting items “Printer Name” and “Computer Name” are different, their set values are the same. Therefore, first, the network setting information print formatting means 6 (FIG. 18) obtains those setting items as a set value which is related to the category “Ether Talk” to which the setting item “Printer Name” has been grouped together (step S4-14). After that, the same set value is obtained as a set value of “Computer Name” related to the category “NetBEUI” to which the setting item “Computer Name” has been grouped together (step S4-16).

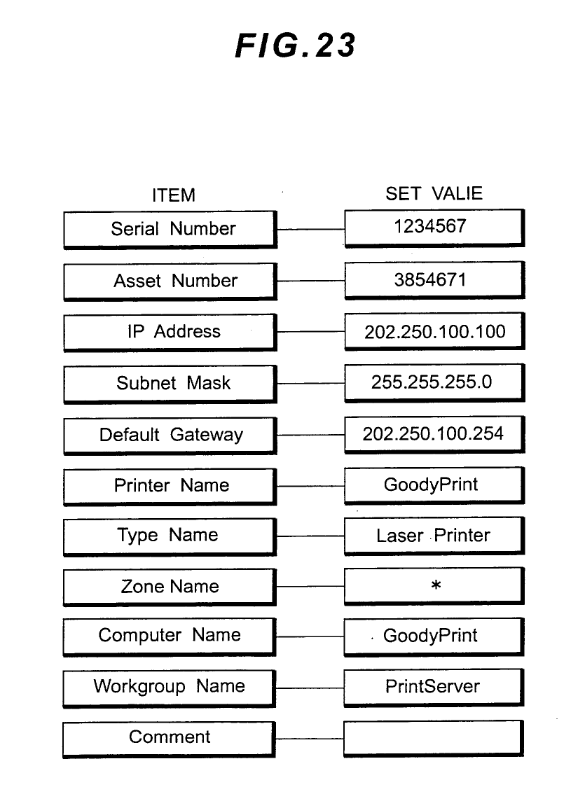

FIG. 23 is an explanatory diagram of the information searching method in the embodiment 4 (part 2).

This diagram is a diagram for explaining the method whereby on the basis of the control of the print control unit 42 (FIG. 18), the network setting information print formatting means 6 (FIG. 18) obtains the set value which has been changed on the basis of the changed setting item detected from the change point information storing unit 21 (FIG. 18).

The set value of the changed setting item “IP Address” (the column on the left side of the diagram) which is grouped together to “TCP/IP” and “NetBEUI” obtained in FIG. 22 mentioned above is obtained as “202.250.100.100” (the column on the right side of the diagram). Similarly, the set value of the changed setting items “Printer Name” and “Computer Name” (the column on the left side of the diagram) is obtained as “Goody Print” (the column on the right side of the diagram).

Therefore, the network setting information print formatting means 6 (FIG. 18) searches for the setting item whose set value has been changed by using the change point flags stored in the change point information storing unit 41 (FIG. 18), searches the network database 7 (FIG. 18) on the basis of the search result, and detects the changed set value. The categories and setting items which were detected as mentioned above and the changed set values are arranged as shown in FIG. 7 and print-outputted.

As described above, there is obtained an effect that even in the case where the setting item has been overlapped and grouped together to a plurality of categories, the changed set value is print-outputted by the print-output request of only the change point, and in the case where although the names of the setting items are different, their set values are common, if one of them is changed, the other is also displayed.

Although the invention has been described above on the assumption that all of the printer setting information print accepting means (1) 1 (FIG. 18), the printer setting information print accepting means (2) 2 (FIG. 18), the printer setting information print formatting means 4 (FIG. 18), and the network setting information print formatting means 6 (FIG. 18) are constructed by the control means of the print control unit 42 (FIG. 18), the invention is not limited to this example. That is, all or a part of the printer setting information print accepting means (1) 1 (FIG. 18), the printer setting information print accepting means (2) 2 (FIG. 18), the printer setting information print formatting means 4 (FIG. 18), and the network setting information print formatting means 6 (FIG. 18) can be also constructed by a dedicated electronic circuit.

Further, although it is assumed in the above description that the change point flag information has been stored in the change point information storing unit 41 (FIG. 18), the invention is not limited to such an example. That is, the invention is not limited to the change point flag information but any information can be used so long as it can hold a fact that the set value has been changed. Although the case where only the color and font type are used as different expressing formats has been described above, the invention is not limited to such an example. That is, another expressing format in which a specific code is added or the like can be also used.

Although the invention has been described above on the assumption that the application example of the invention is limited to the printer, the invention is not limited to such an example. That is, the invention can be also applied not only to the printer but also to a facsimile apparatus, a copying apparatus, or the like.

The present invention is not limited to the foregoing embodiments but many modifications and variations are possible within the spirit and scope of the appended claims of the invention.

1. An image forming apparatus having a plurality of setting items, comprising:
a setting item memory which stores said plurality of setting items;
a group information memory which stores predetermined group information so that said plurality of setting items stored in said setting item memory are grouped together to every related setting item; and
a print control unit which, when a print-output request of said setting items is received, obtains said related setting item from said setting item memory on the basis of said group information and print-outputs said related setting item.

2. The image forming apparatus according to claim 1, wherein said print control unit comprises:
selection item accepting means which receives said print-output request every group on the basis of a selection item so that the related setting item is grouped together to a predetermined group; and
setting information print formatting means which obtains the setting item from said setting item memory on the basis of said group information corresponding to said selection item and outputs the obtained setting item in a predetermined format.

3. The image forming apparatus according to claim 1, wherein said group information is predetermined protocol information so that said plurality of setting items stored in said setting item memory are grouped together every predetermined protocol.

4. An image forming apparatus having a plurality of setting items, comprising:
a setting item memory which stores said plurality of setting items;
a change point information storing unit which stores information regarding the setting item whose setting contents have been changed among the plurality of setting items stored in said setting item memory; and
a print control unit which, when a print-output request of said setting items is received, obtains a predetermined setting item from said setting item memory on the basis of said information regarding said changed setting item and print-outputs said predetermined setting item.

5. The image forming apparatus according to claim 4, wherein said print control unit comprises:
selection item accepting means which receives said print-output request on the basis of the predetermined selection item which designates the setting item whose setting contents have been changed; and
setting information print formatting means which obtains the setting item from said setting item memory on the basis of the information regarding the setting item which corresponds to said selection item and whose setting contents have been changed and outputs the obtained setting item in a predetermined format.

6. The image forming apparatus according to claim 4, wherein said change point information storing unit stores identification information of the setting item whose setting contents have been changed.

7. The image forming apparatus according to claim 4, wherein said change point information storing unit further stores a plurality of summary information in which said setting item is grouped together to a plurality of category and set value sharing information in which said setting item shares same setting contents.

8. An image forming apparatus having a plurality of setting items, comprising:
a setting item memory which stores said plurality of setting items;
a change point information storing unit which stores information regarding the setting item whose setting contents have been changed among the plurality of setting items stored in said setting item memory; and
a print control unit which, when a print-output request of said setting items is received, obtains a predetermined setting item from said setting item memory on the basis of said information regarding said changed setting item and print-outputs said predetermined setting item in a predetermined changed expressing format.

9. The image forming apparatus according to claim 8, wherein said print control unit comprises:
selection item accepting means which receives said print-output request on the basis of a predetermined selection item which designates the setting item whose setting contents have been changed; and
setting information print formatting means which obtains the setting item from said setting item memory on the basis of the information regarding the setting item which corresponds to said selection item and whose setting contents have been changed and outputs the obtained setting item in said predetermined changed expressing format.
